(19) United States
(12) Patent Application Publication
(10) Pub. No.: US 2022/0335566 A1
(43) Pub. Date: Oct. 20, 2022

(54) METHOD AND APPARATUS FOR PROCESSING POINT CLOUD DATA, DEVICE, AND STORAGE MEDIUM

(71) Applicant: SENSETIME INTERNATIONAL PTE. LTD., Singapore (SG)

(72) Inventors: Zhongang CAI, Singapore (SG); Xinyi CHEN, Singapore (SG); Junzhe ZHANG, Singapore (SG); Haiyu ZHAO, Singapore (SG); Shuai YI, Singapore (SG)

(21) Appl. No.: 17/364,367

(22) Filed: Jun. 30, 2021

Related U.S. Application Data
(63) Continuation of application No. PCT/IB2021/054792, filed on Jun. 1, 2021.

(30) Foreign Application Priority Data
Apr. 15, 2021 (SG) 10202103894R

(51) Int. Cl. G06T 3/40; G06T 5/50; G06T 17/00

(52) U.S. Cl. CPC G06T 3/40; G06T 5/50; G06T 17/00; G06T 2207/20221; G06T 2207/20016

(57) ABSTRACT

A method and apparatus for processing point cloud data, a device, and a storage medium are provided. The method includes: determining, from first point cloud data acquired, multiple groups of neighbouring points for a to-be-processed point, wherein each group of neighbouring points among the multiple groups of neighbouring points has a respective different scale; for each group of neighbouring points, determining a respective association relationship between the group of neighbouring points and the to-be-processed point; for each group of neighbouring points, determining a respective association feature of the to-be-processed point based on the respective association relationship; determining a target feature of the to-be-processed point based on association features corresponding to the multiple groups of neighbouring points; and performing, based on target features of multiple to-be-processed points, point cloud completion on the first point cloud data to generate second point cloud data.

### CROSS-REFERENCE TO RELATED APPLICATION

The present application is a continuation of International Application No. PCT/IB2021/054792, filed on 1 Jun. 2021, which claims priority to Singapore Patent Application No. 10202103894R, filed to the Singapore Patent Office on 15 Apr. 2021 and entitled “METHOD AND APPARATUS FOR PROCESSING POINT CLOUD DATA, DEVICE, AND STORAGE MEDIUM”. The contents of International Application No. PCT/IB2021/054792 and Singapore Patent Application No. 10202103894R are incorporated herein by reference in their entireties.

### BACKGROUND

As laser radars and depth cameras are becoming more mature, point cloud is gradually deployed in various monitoring scenarios as a supplementary data format for pictures. In the related art, it is difficult for point cloud features learned by a deep neural network to meet application requirements, due to the disorder, noise and meshless characteristics of the point cloud.

### SUMMARY

Embodiments of the disclosure relate to the technical field of processing point cloud data, and relate to but are not limited to a method and apparatus for processing point cloud data, a device, and a storage medium.

An embodiment of the disclosure provides a method for processing point cloud data, including: determining, from first point cloud data acquired, a plurality of groups of neighbouring points for a to-be-processed point, wherein each group of neighbouring points among the plurality of groups of neighbouring points has a respective different scale; for each group of neighbouring points, determining a respective association relationship between the group of neighbouring points and the to-be-processed point; for each group of neighbouring points, determining a respective association feature of the to-be-processed point based on the respective association relationship between the group of neighbouring points and the to-be-processed point; determining a target feature of the to-be-processed point based on association features corresponding to the plurality of groups of neighbouring points; and performing, based on target features of a plurality of to-be-processed points, point cloud completion on the first point cloud data to generate second point cloud data.

An embodiment of the disclosure provides an apparatus for processing point cloud data, including: a first determination module, configured to determine, from first point cloud data acquired, a plurality of groups of neighbouring points for a to-be-processed point, wherein each group of neighbouring points among the plurality of groups of neighbouring points has a respective different scale; a second determination module, configured to: for each group of neighbouring points, determine a respective association relationship between the group of neighbouring points and the to-be-processed point; a third determination module, configured to: for each group of neighbouring points, determine a respective association feature of the to-be-processed point based on the respective association relationship between the group of neighbouring points and the to-be-processed point; and a fourth determination module, configured to determine a target feature of the to-be-processed point based on association features corresponding to the plurality of groups of neighbouring points.

An embodiment of the disclosure provides an apparatus for processing point cloud data, including: a processor; and a memory configured to store instructions which, when being executed by the processor, cause the processor to carry out the following: determining, from first point cloud data acquired, a plurality of groups of neighbouring points for a to-be-processed point, wherein each group of neighbouring points among the plurality of groups of neighbouring points has a respective different scale; for each group of neighbouring points, determining a respective association relationship between the group of neighbouring points and the to-be-processed point; for each group of neighbouring points, determining a respective association feature of the to-be-processed point based on the respective association relationship between the group of neighbouring points and the to-be-processed point; determining a target feature of the to-be-processed point based on association features corresponding to the plurality of groups of neighbouring points; and performing, based on target features of a plurality of to-be-processed points, point cloud completion on the first point cloud data to generate second point cloud data.

Accordingly, an embodiment of the disclosure provides a non-transitory computer storage medium having stored thereon computer-executable instructions which, when being executed, are capable of implementing the following actions: determining, from first point cloud data acquired, a plurality of groups of neighbouring points for a to-be-processed point, wherein each group of neighbouring points among the plurality of groups of neighbouring points has a respective different scale; for each group of neighbouring points, determining a respective association relationship between the group of neighbouring points and the to-be-processed point; for each group of neighbouring points, determining a respective association feature of the to-be-processed point based on the respective association relationship between the group of neighbouring points and the to-be-processed point; determining a target feature of the to-be-processed point based on association features corresponding to the plurality of groups of neighbouring points; and performing, based on target features of a plurality of to-be-processed points, point cloud completion on the first point cloud data to generate second point cloud data.

An embodiment of the disclosure provides a computer device including a memory and a processor, wherein the memory has stored thereon computer-executable instructions, and the processor is capable of implementing actions of the above method when executing the computer-executable instructions on the memory.

### BRIEF DESCRIPTION OF THE DRAWINGS

FIG. 1 illustrates a schematic flowchart of an implementation of a method for processing point cloud data according to an embodiment of the disclosure;

FIG. 2 illustrates a schematic flowchart of another implementation of the method for processing point cloud data according to an embodiment of the disclosure;

FIG. 3 illustrates a schematic diagram of a composition structure of an apparatus for processing point cloud data according to an embodiment of the disclosure; and

FIG. 4 illustrates a schematic diagram of a composition structure of a computer device according to an embodiment of the disclosure.

### DETAILED DESCRIPTION

In order to make the purpose, technical solutions and advantages of the embodiments of the disclosure more clear, particular technical solutions of the disclosure will be described in further detail below in conjunction with the accompanying drawings in the embodiments of the disclosure. The following embodiments are intended to explain the disclosure, but are not intended to limit the scope of the disclosure.

In the following descriptions, reference is made to “some embodiments”, which describes a subset of all possible embodiments; however, it should be understood that “some embodiments” may be the same subset or different subset of all possible embodiments, and may be combined with each other without confliction.

The terminology “first/second/third” used in the following descriptions is merely for making distinction between similar objects and does not represent a specific ordering for the objects. It may be understood that “first/second/third” may be present in an inter-changeable order or a sequential order under allowable conditions, so that the embodiments of the disclosure described herein may be implemented in an order besides that illustrated or described herein.

Unless defined otherwise, all technical and scientific terminologies used herein have the same meaning as commonly understood by those skilled in the art to which the disclosure belongs. The terminologies used herein are for the purpose of describing the embodiments of the disclosure only and are not intended to limit the disclosure.

Before the embodiments of the disclosure are described in further detail, the terms and terminologies used in the embodiments of the disclosure are described, and the terms and terminologies used in the embodiments of the disclosure are applicable to the following explanations.

1) Global average pooling: also referred to as under-sampling or down-sampling, and mainly used for reducing the dimensions of a feature, compressing data and the number of parameters, reducing over-fitting, and improving the fault tolerance of a model.

2) Fully connected layer: used for integrating features which are highly abstracted after having subjected to multiple convolutions previously, and then performing normalization thereon to output a probability for each class so that a subsequent classifier performs classification according to probabilities obtained through the fully connected layer.

An exemplary application of an apparatus for processing point cloud data provided in an embodiment of the disclosure will be described below. The apparatus provided in the embodiment of the disclosure may be implemented as various types of user terminals having a picture acquisition function such as a laptop, a tablet, a desktop computer, a camera, a mobile device (e.g., a personal digital assistant, a dedicated messaging device, a portable game device) etc., or may be implemented as a server. An exemplary application where the device is implemented as a terminal or a server will be described below.

The method may be applied to a computer device. The functions implemented by the method may be implemented by a processor in the computer device calling program codes which of course may be stored in a computer storage medium. It may be seen that the computer device includes at least the processor and the storage medium.

Embodiments of the disclosure provide a method and apparatus for processing point cloud data, a device, and a storage medium. For any to-be-processed point in first point cloud data, firstly, association relationships of multiple groups of neighbouring points with different scales with the to-be-processed point are determined; then, an association feature of the to-be-processed point is extracted based on the association relationship between each group of neighbouring points and the to-be-processed point; then, the target feature of the to-be-processed point is obtained by fusing the association features of the multiple groups of neighbouring points; and finally, completion is performed on the first point cloud data based on the target features of multiple to-be-processed points in the first point cloud data, to generate the second point cloud data. In this way, the point cloud features with different scales can be considered by fusing the features of multiple groups of neighbouring points with different scales, so that the extracted point cloud feature has an invariant scale within a certain range, the extracted point cloud features are richer. Thus, the point cloud obtained by performing the point cloud completion based on the extracted point cloud features is more complete, and the real three-dimensional objects of the physical space can be characterized more accurately.

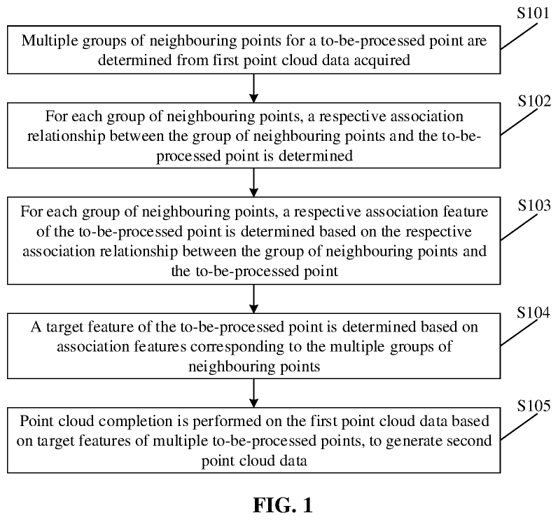

An embodiment of the disclosure provides a method for processing point cloud data. As illustrated in FIG. 1, the method is described with reference to the operations illustrated in FIG. 1.

In operation S101: multiple groups of neighbouring points for a to-be-processed point are determined from first point cloud data acquired.

In some embodiments, the first point cloud data acquired may be three-dimensional (3D) point cloud data acquired directly, or may be 3D point cloud data received from other devices. The to-be-processed point may be understood as any point in the point cloud data. In the point cloud data, multiple groups of neighbouring points are determined with the to-be-processed point as a center point. Among the multiple groups of neighbouring points, each group of neighbouring points has a respective different scale. The scale of each group of neighbouring points represents the number of neighbouring points in the group of neighbouring points. Namely, each group of neighbouring points among the multiple groups of neighbouring points includes a respective different number of neighbouring points. For example, for the to-be-processed point, a group of neighbouring points includes K1 neighbouring points, and another group of neighbouring points includes K2 neighbouring points, then the scales of these two groups of neighbouring points are determined to be K1 and K2, respectively.

In operation S102: for each group of neighbouring points, a respective association relationship between the group of neighbouring points and the to-be-processed point is determined.

In some embodiments, for each group of neighbouring points, the association relationship between the group of neighbouring points and the to-be-processed point is used to characterize the association degree between each neighbouring point in the group of neighbouring points and the to-be-processed point. The association relationship may include a position relationship; and/or the association relationship may characterize potential association between a physical object characterized by each neighbouring point in the group of neighbouring points and a physical object characterized by the to-be-processed point. For example, the potential association includes whether the neighbouring point characterizes the same physical object as the to-be-processed point does; or in the case where the neighbouring point and the to-be-processed point characterize different physical objects, the potential association includes at least one of a position relationship, a similarity in category, a subordination relation, etc. between the different physical objects characterized. The association relationship may be represented by relationship parameters between the neighbouring points and the to-be-processed point, and weight coefficients. For each group of neighbouring points among the multiple groups of neighbouring points, the relationship parameter between each neighbouring point in the group of neighbouring points and the to-be-processed point is analyzed. Based on the relationship parameters, the association relationship between the group of neighbouring points and the to-be-processed point may be determined generally. As such, the association relationship between each group of neighbouring points and the to-be-processed point is obtained.

In operation S103: for each group of neighbouring points, a respective association feature of the to-be-processed point is determined based on the respective association relationship between the group of neighbouring points and the to-be-processed point.

In some embodiments, the number of association features of the to-be-processed point corresponds to the number of groups of neighbouring points. Namely, an association feature of the to-be-processed point corresponding to a group of neighbouring points may be obtained by interaction processing of the group of neighbouring points with the to-be-processed point. The feature information of the group of neighbouring points is fully considered in the association feature corresponding to the group of neighbouring points. The to-be-processed point has multiple groups of neighbouring points, and thus there are multiple association features.

In some possible implementations, firstly, interaction processing is performed on the feature of each neighbouring point in a group of neighbouring points and the feature of the to-be-processed point according to the relationship parameter, so as to obtain a set of initial features having subjected to the interaction processing. Then, the initial features having subjected to the interaction are fused by groups, to obtain the association feature of the to-be-processed point corresponding to each group of neighbouring points. In the association features of the to-be-processed point, the association relationship with the initial features of the surrounding multiple groups of neighbouring points are considered, so that the obtained association features of the to-be-processed point are more critical and more abundant.

In operation S104: a target feature of the to-be-processed point is determined based on association features corresponding to the multiple groups of neighbouring points.

In some embodiments, the association features corresponding to the multiple of neighbouring points may be fused to obtain the target feature of the to-be-processed point. For the multiple groups of neighbouring points of the to-be-processed point, a point self-attention kernel module of a relationship promotion network in a point cloud completion network (herein the point self-attention kernel module is a part of the relationship promotion network, and structural relations within the point cloud are learned by integrating features of local neighbouring points and relationships between the to-be-processed point and the neighbouring points, thereby enhancing the point cloud feature) is used to obtain the association feature corresponding to each group of neighbouring points. In this way, the weighted sum of the association features is solved with respective weights of the association features, to obtain the target feature in which the features of the multiple groups of neighbouring points are considered. As such, by means of the association relationships between the neighbouring points that are adaptively selected in different scales and the to-be-processed point and by determining the target feature of the to-be-processed point based on multiple association features, not only the scale invariance is enabled within a certain range in point cloud learning, but also the point cloud feature can be enhanced.

In operation S105: point cloud completion is performed on the first point cloud data based on target features of multiple to-be-processed points, to generate second point cloud data.

In some embodiments, the second point cloud data is more complete than the first point cloud data. Optionally, a contour of original point cloud data may be estimated roughly by analyzing probability distribution of the original point cloud data, so as to obtain the first point cloud data. The point cloud feature enhancement is performed, based on the target feature, on the first point cloud data that is obtained by the rough estimation, so as to obtain refined second point cloud data.

In the embodiment of the disclosure, the target feature of the to-be-processed point is extracted by using a relationship promotion network in a variational relational point completion network in combination with the association features of multiple groups of neighbouring points with different scales; and the first point cloud data is completed by using the target features of multiple to-be-processed points, to obtain more integral second point cloud data. In this way, the point cloud features at different scales can be considered by fusing the features of multiple groups of neighbouring points with different scales. The extracted point cloud features have an invariant scale within a certain range, and the extracted point cloud features are more abundant. The point cloud obtained by performing point cloud completion based on the extracted point cloud features has better integrity, and the real three-dimensional objects in the physical space may be characterized more accurately.

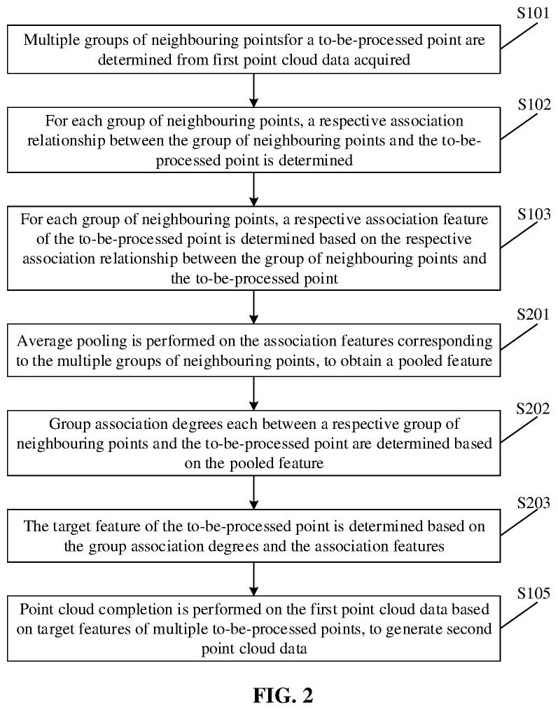

In some embodiments, global average pooling is performed for multiple association features, and a group association degree of each group of neighbouring points in the association feature is determined, so that the target feature is extracted by combining group association degrees and the association features of the groups of neighbouring points respectively. That is, the operation S104 may be implemented by the operations illustrated in FIG. 2, and the following description is made in combination with the operations illustrated in FIGS. 1 and 2.

In operation S201: average pooling is performed on the association features corresponding to the multiple groups of neighbouring points, to obtain a pooled feature.

In some embodiments, in order to determine which group of neighbouring points is more important for the to-be-processed point, the association features corresponding to the multiple groups of neighbouring points are fused firstly, and then a pooling layer is used to perform average pooling on the fused feature, to obtain the pooled feature.

In some possible implementations, firstly, the association features corresponding to the multiple groups of neighbouring points are fused to obtain a fused feature. For example, the association features corresponding to the multiple groups of neighbouring points are added in an element-wise manner to obtain a fused feature. Then, average pooling is performed on the fused feature, to obtain the pooled feature. For example, the fused feature obtained by element-wise addition is input to a global average pooling layer of the network, to perform global average pooling on the fused feature. Thus, the pooled feature is obtained by reducing the dimensions of the fused features, to improve the robustness of the network.

In operation S202: group association degrees each between a respective group of neighbouring points and the to-be-processed point are determined based on the pooled feature.

In some embodiments, firstly, the pooled feature is input to a fully connected layer in a network architecture, to classify, for each group of neighbouring points, the importance of each neighbouring point in the group of neighbouring points for the to-be-processed point, to obtain a set of neighbouring points marked with importance. Then, two fully connected layers are respectively used to determine neighbouring points belonging to a same group by classification from the set of neighbouring points marked with importance. Finally, based on the importance marked on the same group of neighbouring points, the importance, i.e., the group association degree, of the group of neighbouring points for the to-be-processed point may be determined.

In operation S203: the target feature of the to-be-processed point is determined based on the group association degrees and the association features.

In some embodiments, firstly, the group association degree of each group of neighbouring points and the association feature corresponding to the group of neighbouring points are multiplied in an element-wise manner as two vectors, so that multiplication results corresponding to multiple groups of neighbouring points may be obtained. Then, the multiplication results corresponding to the multiple groups of neighbouring points are added in an element-wise manner to obtain a final target feature.

In the embodiment of the disclosure, after multiple association features are fused, global average pooling is performed on the fused feature, and the pooled feature is input to the fully connected layer to determine importance of each group of neighbouring points in the association features. The importance of each group of neighbouring points is combined with the association feature corresponding to the group of neighbouring points to obtain the final target feature. In this way, by combining the group association degrees of multiple groups of neighbouring points at different scales with the association features of the multiple groups of neighbouring points respectively, the target feature of the point cloud with richer details can be extracted. It is achieved that multiple features with different scales may be selected and fused in the same layer so that the trained network may cope with the association features at multiple scales during training the point cloud completion network based on the point cloud features.

In some embodiments, the group association degree of a group of neighbouring points may be obtained by determining the association degree of each neighbouring point in the group of neighbouring points with the to-be-processed point, so that the association feature corresponding to the group of neighbouring points may be updated by using the group association degree, so as to obtain the target feature. That is, the operations S202 and S203 may be implemented by the following operations.

In operation S231: for each group of neighbouring points, a respective point association degree set is obtained by: determining, based on the pooled feature, an association degree between each neighbouring point in the group of neighbouring points and the to-be-processed point.

In some embodiments, for each group of neighbouring points, the importance of each neighbouring point in the group of neighbouring points for the to-be-processed point is determined, so that the association degree of the neighbouring point with the to-be-processed point may be determined. For example, the confidence that the neighbouring point is a key point for the to-be-processed point is used as the association degree between the neighbouring point and the to-be-processed point.

In some possible implementations, by determining the confidence that each neighbouring point in a group of neighbouring points is a key point for the to-be-processed point, the importance of the group of neighbouring points for the to-be-processed point, i.e., the group association degree, is analyzed. That is, the operation S202 may be implemented by the following operations.

In a first operation, a first confidence that the pooled feature is a key feature of the to-be-processed point is determined.

In some embodiments, the key feature of the to-be-processed point is that a key point in the neighbouring points of the to-be-processed point has a linear relationship and an association relationship with the to-be-processed point. For example, the key point has a close semantic relationship with the to-be-processed point, and there are many interactions there-between.

In a specific example, the association features corresponding to multiple groups of neighbouring points are fused, and the pooled feature obtained from the association features corresponding to the multiple groups are input to a fully connected layer. The fully connected layer is used to classify the important association features among association features corresponding to the multiple groups of neighbouring points. The association feature corresponding to each group of neighbouring points contains the association relationship of the neighbouring points with the to-be-processed point, so that whether each neighbouring point in multiple groups of neighbouring points is a key point or not can be determined. Thus, a first confidence that each neighbouring point is a key point for the to-be-processed point is obtained.

In a second operation, for each group of neighbouring points, a respective second confidence that the respective association feature is the key feature is determined based on the first confidence, so as to obtain a second confidence set.

In some embodiments, in order to determine which group of neighbouring points is more important for the to-be-processed point, multiple association features having been fused together are distinguished by using multiple fully connected layers independent from one another, to obtain the importance of the association feature corresponding to each group of neighbouring points, i.e., the second confidence. Here, the number of independent fully connected layers is the same as the number of groups of neighbouring points, so that the multiple association features having been fused together can be distinguished from one another.

In a third operation, a group association degree of each group of neighbouring points is determined based on the second confidence set.

In some embodiments, the importance of a group of neighbouring points may be obtained by determining the confidence for the association feature corresponding to the group of neighbouring points to be the key feature, and marking the confidence for the association feature. In this way, firstly, the importance of multiple association features having been fused together is classified by the fully connected layer, and then multiple independent fully connected layers are used to distinguish the multiple association features for independent groups of neighbouring points, so that the importance of each group of neighbouring points can be determined.

In operation S232: for each group of neighbouring points, a respective group association degree is determined based on the respective point association degree set.

In some embodiments, a point association degree set of a group of neighbouring points may be understood as a set of confidences for each neighbouring point in the group of neighbouring points to be a key point for the to-be-processed point. The importance of the group of neighbouring points for the to-be-processed point, i.e. the group association degree of the group of neighbouring points, may be obtained by summing the confidences of the group of neighbouring points.

In some possible implementations, after point association degrees of a group of neighbouring points are obtained, the point association degrees are normalized, to obtain a group association degree of the group of neighbouring points. For example, this may be implemented by the following operations.

Firstly, second confidences in the second confidence set are normalized, to obtain group normalization results.

For example, a second confidence corresponding to each group of neighbouring points is input to the softmax layer of the point cloud completion network. The second confidence is processed by using the softmax function, so that a normalization result may be obtained for the second confidence corresponding to each group of neighbouring points. Furthermore, the sum of the group normalization results corresponding to multiple groups of neighbouring points is equal to 1.

Then, the group association degree of each group of neighbouring points is determined based on the group normalization results.

For example, the larger group normalization result indicates that the group of neighbouring points is more important for the to-be-processed point, that is, the probability for the group of neighbouring points to be key points for the to-be-processed point is greater. Thus, by using the softmax layer to process the point association degrees of a group of neighbouring points, the importance of the group of neighbouring points as a whole can be determined, so that the extracted point cloud features may be enhanced according to the importance of the group of neighbouring points as a whole.

In operation S233: for each group of neighbouring points, the respective association feature is adjusted based on the respective group association degree, so as to obtain the target feature.

In some embodiments, the group association degree of each group of neighbouring points is multiplied by the association feature corresponding to the group of neighbouring points in an element-wise manner, to obtain a multiplication result. In this way, multiple multiplication results may be obtained based on the group association degrees of multiple groups of neighbouring points and the corresponding association features. The target feature may be obtained by adding the multiple multiplication results in an element-wise manner. In this way, the association feature corresponding to a group of neighbouring points is adjusted by using the group association degree of the group of neighbouring points, and adjusted association features corresponding to multiple groups of neighbouring points are fused to obtain the target feature capable of containing features of the surrounding multiple groups of neighbouring points with different scales.

In some embodiments, for each neighbouring point in a group of neighbouring points, the interaction processing between the neighbouring point and the to-be-processed point is implemented in an adaptive manner. That is, the operation S102 may be implemented by the following operations.

In operation S121: for each group of neighbouring points, a respective first initial feature is determined, and a second initial feature of the to-be-processed point is determined.

In some embodiments, feature extraction is performed on each neighbouring point in the group of neighbouring points, to obtain a first initial feature. Namely, the first initial feature includes the initial feature of each neighbouring point. Feature extraction is performed on the to-be-processed point to obtain the second initial feature. The feature extraction herein may be implemented by a trained Multi-Layer Perceptron (MLP) network, a convolutional network or the like

In operation S122: for each group of neighbouring points, linear transformation is performed on the respective first initial feature based on a first preset numeric value, to obtain a respective first transformed feature.

In some embodiments, the first preset numeric value may be implemented as any set value. For example, the first preset numeric value is set to 64 or 32, etc. Firstly, linear processing is performed on the first initial feature by using the MLP network, for example, increasing the dimensions of the first initial feature; then linear transformation is performed, according to the first preset numeric value, on the first initial feature of which the dimensions have been increased, to obtain the first transformed feature. For example, the first initial feature of which the dimensions have been increased is reduced in dimensions according to the first preset numeric value, to obtain the first transformed feature.

In operation S123: linear transformation is performed on the second initial feature based on the first preset numeric value, to obtain a second transformed feature.

In some embodiments, the processing of the second initial feature of the to-be-processed point is similar to the processing of the first initial feature in the operation S122. For example, firstly, linear processing is performed on the second initial feature by using the MLP, for example, increasing the dimensions of the second initial feature; then linear transformation is performed, according to the first preset numeric value, on the second initial feature of which the dimensions have been increased, to obtain the second transformed feature. For example, the second initial feature of which the dimensions have been increased is reduced in dimensions according to the first preset numeric value, to obtain the second transformed feature.

In operation S124: for each group of neighbouring points, a respective relationship parameter between the respective first transformed feature and the second transformed feature is determined to be the respective association relationship between the group of neighbouring points and the to-be-processed point.

In some embodiments, interaction processing is performed on the first transformed feature of each group of neighbouring points and the second transformed feature. For example, the first transformed feature of the group of neighbouring points is connected to or multiplied by the second transformed feature to obtain the relationship weight between the two features. The relationship weight is used as the relationship parameter between the two features.

The operations S121 to S124 provide a method for implementing “for each group of neighbouring points, determining a respective association relationship between the group of neighbouring points and the to-be-processed point”. In the method, mutual relationships of neighbouring points with the to-be-processed point are adaptively learned, to extract the key features in the point cloud data.

After the operation S124, linear transformation may be performed on the initial features of the neighbouring points by using another preset numeric value, and the transformed initial features may be adjusted by using the association relationship, so that the association feature corresponding to the group of neighbouring points can be obtained. That is, the operation S103 may be implemented by the following operations.

In operation S131: for each group of neighbouring points, linear transformation is performed, based on a second preset numeric value, on the respective first initial feature to obtain a respective third transformed feature.

In some embodiments, one of the second preset numeric value and the first preset numeric value is a multiple of the other. For example, the first preset numeric value is n times of the second preset numeric value. In a specific example, the first preset numeric value may be set to 64 and the second preset numeric value may be set to 32. In some possible implementations, firstly, linear processing is performed on the first initial feature by using a MLP model, for example, increasing the dimensions of the first initial feature; then linear transformation is performed, according to the second preset numeric value, on the first initial feature of which the dimensions have been increased, to obtain the third transformed feature.

In operation S132: for each group of neighbouring points, the respective association feature of the to-be-processed point is determined based on the respective association relationship and the respective third transformed feature.

In some embodiments, the third transformed feature of each group of neighbouring points is enhanced according to the association relationship, and features in the enhanced third transformed feature of the group of neighbouring points are fused to obtain the association feature corresponding to the group of neighbouring points. In this way, linear transformation is performed on the initial feature of a group of neighbouring points by the second preset numeric value which is a multiple of the first preset numeric value; the initial features of the neighbouring points having subjected to linear transformation are enhanced by using the association relationship between the initial feature of the to-be-processed point and the initial feature of the group of neighbouring points, so that the association feature containing richer detail features may be obtained.

In some possible implementations, the third transformed feature is aggregated by using the obtained relationship parameter, and the obtained aggregated feature is fused with the initial feature of the to-be-processed point, so that the association feature containing key information can be obtained. This may be implemented by the following process.

Firstly, for each group of neighbouring points, the respective third transformed feature is aggregated based on the respective relationship parameter, to obtain a respective aggregated feature.

In some embodiments, if the relationship parameter is a relationship weight between the initial feature of the to-be-processed point and the initial feature of a group of neighbouring points, then the relationship weight is used to aggregate the third transformed feature of the group of neighbouring points, to obtain the aggregated feature. For example, the weighted sum of the third transformed feature of the group of neighbouring points is solved using the relationship weight, to obtain the aggregated feature.

Then, the aggregated feature and the second initial feature are fused to obtain the association feature of the to-be-processed point.

In some embodiments, after obtaining the aggregated feature, linear transformation is performed on the aggregated feature by using the MLP network, to obtain a transformed feature with one dimension for the initial feature of the neighbouring points. The transformed feature is added to the initial feature of the to-be-processed point in an element-wise manner, to obtain the association feature of the to-be-processed point. In this way, the association feature of the to-be-processed point is jointly determined by combining the transformed feature having subjected to complex computation with the second initial feature without subjecting to complex computation, so that the original features of the input point cloud data can be retained.

In some embodiments, after acquiring the point cloud data, linear transformation is performed on the initial feature of the to-be-processed point for a first time, and multiple groups of neighbouring points are determined by using the to-be-processed point having subjected to linear transformation as a center point. This may be implemented by the following operations.

In a first operation, linear transformation is performed on the to-be-processed point, to obtain a transformed to-be-processed point.

In some embodiments, linear transformation is performed on the initial feature of the to-be-processed point by using the MLP network, and the transformed initial feature is used as the initial feature of the to-be-processed point.

In a second operation, the multiple groups of neighbouring points are determined for the transformed to-be-processed point.

In some embodiments, multiple groups of neighbouring points are determined by using the transformed to-be-processed point as a center point. That is, before the operation that “for each group of neighbouring points, linear transformation is performed on the respective first initial feature based on a first preset numeric value, to obtain a respective first transformed feature”, linear transformation is performed on the to-be-processed point. In this way, by entering a point self-attention (PSA) kernel module to adaptively learn the structural relations within the point cloud after performing the linear transformation on the initial feature of the to-be-processed point, more feature information that is effective can be obtained.

In some embodiments, the gradient in the target feature extraction process is supplemented by adding a residual path. That is, the method further includes the following operations after the operation S104.

In operation S141: linear transformation is performed on the target feature, to obtain a core target feature.

In some embodiments, after the target feature of the to-be-processed point is determined by using the multiple groups of neighbouring points with different scales, linear transformation is performed on the target feature by using an MLP model, to change the number of dimensions in a feature vector in the target feature so as to obtain the core target feature.

In operation S142: linear transformation is performed on a second initial feature of the to-be-processed point, to obtain a residual feature of the to-be-processed point.

In some embodiments, firstly, feature extraction is performed on the input to-be-processed point to obtain the second initial feature; then, linear transformation is performed on the second initial feature by using a MLP model, to obtain the residual feature. In this way, the residual feature may be used as a newly added residual path, so that the case where the gradient of the main path disappears after complex processing may be solved.

In operation S143: the target feature is updated based on the residual feature and the core target feature, to obtain an updated target feature.

In some embodiments, the residual feature is added to the core target feature in an element-wise manner, to achieve further enhancement of the target feature, i.e., to obtain the updated target feature. In this way, the gradient that disappears during complex processing on the initial feature may be supplemented by adding a residual path. Moreover, in the updated target feature obtained finally, not only the original feature information but also the feature information having subjected to complex processing is considered, so that the updated target feature contains richer details.

Hereinafter, an exemplary application of the embodiment of the disclosure in an actual application scenario will be described. Description is made with the example that multiple groups of neighbouring points with different scales are adaptively selected to enable scale invariance within a certain range in the point cloud learning.

In some embodiments, a reasonable contour of original point cloud data is roughly estimated by considering the probability distribution of the original point cloud data. On this basis, the roughly estimated contour is completed with details, to obtain refined and complete second point cloud data. The first point cloud data may be obtained through the following operations S111 to S114.

In S111, original point cloud data is acquired.

In some embodiments, the acquired original point cloud data may be three-dimensional (3D) point cloud data directly acquired, or may be 3D point cloud data received from another device. The to-be-processed point may be understood as any point in the point cloud data. For example, the original point cloud data may be point cloud data characterizing appearance of a table lamp that is acquired with a certain angle of view for the table lamp, or point cloud data characterizing some object sent by any device. The original point cloud data may be point cloud data that can characterize the complete shape of an object, or may be incomplete point cloud that can characterize part of the shape of the object.

In S112, probability distribution of the original point cloud data is determined.

In some embodiments, the probability distribution of the original point cloud data is conditional probability distribution obtained by encoding the original point cloud data. For example, the probability distribution of the original point cloud data is determined by a point cloud completion network. The point cloud completion network includes two parts: a probability generation network for generating primary complete point cloud, and a relational enhancement network for generating high-quality output point cloud based on the primary complete point cloud. The resulting complete point cloud largely retains the details of the input point cloud. By encoding the original point cloud data by using a variational auto-encoder of the probability generation network, and processing the encoded point cloud by using a linear residual module, the conditional probability distribution of the original point cloud data can be determined quickly.

In S113, the original point cloud data is completed based on the probability distribution, to obtain primary complete point cloud.

In some embodiments, in a point cloud completion network, the complete shape of an object to which the original point cloud data belongs is predicted by referring to the difference between the probability distribution of the point cloud to be completed and the standard normal distribution; and the original point cloud data is completed through the difference between the point cloud data of the complete shape and the original point cloud data, so that a roughly estimated primary complete point cloud can be obtained. The primary complete point cloud is used to roughly describe the general contour of the object to which the original point cloud data belongs.

In S114, the primary complete point cloud and the original point cloud data are cascaded to obtain the first point cloud data.

In some embodiments, the estimated rough contour of the original point cloud data, i.e., the primary complete point cloud is combined with the original point cloud data to obtain the cascaded point cloud data.

The operations S111 to S114 may be implemented by using the probability generation network of the point cloud completion network. During training the probability generation network, the distribution and features of the incomplete point cloud and the distribution and features of the complete point cloud corresponding thereto are learned, so that rough point cloud conforming to the shape of the incomplete point cloud and having a reasonable contour can be generated during application. That is, a primary complete point cloud with a reasonable contour corresponding to the network to be completed can be generated by using the probability generation network. The primary complete point cloud output by the probability generation network is combined with the original point cloud data to obtain first point cloud data, and then input to a relationship promotion network of the point cloud completion network, that is, the operation S115 is entered.

In S115, point cloud completion is performed on features of the original point cloud data based on target features of multiple to-be-processed points in the first point cloud data, to generate second point cloud data.

In some embodiments, in a relationship promotion network, for each point in the first point cloud data, firstly, multiple groups of neighbouring points with different scales are determined for the point; then, an association relationship between each group of neighbouring points and the point is determined. Herein, the association relationship is used to characterize interaction between each neighbouring point in the group of neighbouring points and the point, and may be represented by an interaction parameter and a weight coefficient between the neighbouring point and the point. For each group of neighbouring points among the multiple groups of neighbouring points, the association parameter between each neighbouring point in the group of neighbouring points and the point is analyzed, and the association relationship between the group of neighbouring points and the point may be determined based on the interaction parameters in general. As such, the association relationship between each group of neighbouring points and the point can be obtained. In this way, the association relationship between the whole cascaded point cloud and multiple groups of neighbouring points in the cascaded point cloud can be obtained by determining the association relationship between each point and multiple groups of neighbouring points. In this way, the precision of point cloud completion is improved, by learning the structural relations of the neighbouring points with different scales in the point cloud.

The point cloud feature of the primary complete point cloud is enhanced according to an association relationship between a group of neighbouring points and the point in the first point cloud data, to obtain a refined point cloud feature. The original point cloud data is completed by the refined point cloud feature, to obtain second point cloud data. In this way, the reasonable contour of the original point cloud data can be predicted by considering the probability distribution of the point cloud to be completed, thereby obtaining a primary complete point cloud conforming to the shape of the original point cloud data and has a reasonable contour. Moreover, the precision of the primary complete point cloud can be improved by combining the structural relations of multiple groups of neighbouring points with different scales in the cascaded point cloud, so that the second point cloud data with highly accurate point cloud details can be obtained.

In a specific example, the original cloud data acquired in a game place is used as the first point cloud data. For a game in the game place, a point cloud acquisition device is used to perform image acquisition on a game table where the game is played, a player, game coins etc., to obtain the original point cloud data. Since the player may look down at the game coins or the like in the game place, it is difficult to acquire a complete face picture of the player in this case; alternatively, the acquired image of the game coin is also incomplete due to occlusion of the player's hand or the like. As such, the original point cloud data acquired by single point cloud acquisition device is incomplete due to the occlusion or the like, and it is difficult to accurately detect the position relationship between players by the incomplete point cloud data. In the embodiment of the disclosure, firstly, the contour of the original point cloud data is roughly estimated, and then roughly estimated first point cloud data is obtained by combining the estimated rough point cloud with the original point cloud data; finally, the detail information of the incomplete original point cloud data is recovered by performing detail enhancement on the features in the first point cloud data, so that the completion of the original point cloud data is realized to obtain second point data with a complete shape. In this way, the accurate detection of the position relationship between game objects is facilitated by performing completion on the incomplete original point cloud data.

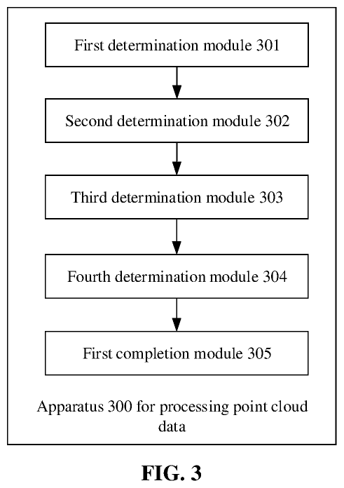

An embodiment of the disclosure provides an apparatus for processing point cloud data. FIG. 3 illustrates a schematic diagram of a composition structure of an apparatus for processing point cloud data according to an embodiment of the disclosure. As illustrated in FIG. 3, the apparatus 300 for processing point cloud data includes a first determination module 301, a second determination module 302, a third determination module 303, a fourth determination module 304 and a first completion module 305.

The first determination module 301 is configured to determine, from first point cloud data acquired, a plurality of groups of neighbouring points for a to-be-processed point. Each group of neighbouring points among the plurality of groups of neighbouring points has a respective different scale.

The second determination module 302 is configured to: for each group of neighbouring points, determine a respective association relationship between the group of neighbouring points and the to-be-processed point.

The third determination module 303 is configured to: for each group of neighbouring points, determine a respective association feature of the to-be-processed point based on the respective association relationship between the group of neighbouring points and the to-be-processed point.

The fourth determination module 304 is configured to determine a target feature of the to-be-processed point based on association features corresponding to the plurality of groups of neighbouring points.

The first completion module 305 is configured to perform, based on target features of a plurality of to-be-processed points, point cloud completion on the first point cloud data to generate second point cloud data.

In some embodiments, the fourth determination module 304 includes a first processing submodule, a first determination submodule and a second determination submodule.

The first processing submodule is configured to perform average pooling on the association features corresponding to the plurality of groups of neighbouring points, to obtain a pooled feature.

The first determination submodule is configured to determine, based on the pooled feature, group association degrees each between a respective group of neighbouring points and the to-be-processed point.

The second determination submodule is configured to determine, based on the group association degrees and the association features, the target feature of the to-be-processed point.

In some embodiments, the first processing submodule includes a first fusion unit, and a first processing unit.

The first fusion unit is configured to fuse the association features corresponding to the multiple groups of neighbouring points, to obtain a fused feature.

The first processing unit is configured to perform average pooling on the fused feature, to obtain the pooled features.

In some embodiments, the first determination submodule includes a first determination unit and a second determination unit, and the second determination submodule includes a first adjustment unit.

The first determination unit is configured to: for each group of neighbouring points, obtain a respective point association degree set by: determining, based on the pooled feature, an association degree between each neighbouring point in the group of neighbouring points and the to-be-processed point.

The second determination unit is configured to: for each group of neighbouring points, determine a respective group association degree based on the respective point association degree set.

The first adjustment unit is configured to: for each group of neighbouring points, adjust the respective association feature based on the respective group association degree, so as to obtain the target feature.

In some embodiments, the first determination submodule includes a third determination unit, a fourth determination unit and a fifth determination unit.

The third determination unit is configured to determine a first confidence that the pooled feature is a key feature of the to-be-processed point.

The fourth determination unit is configured to: for each group of neighbouring points, determine, based on the first confidence, a respective second confidence that the respective association feature is the key feature, so as to obtain a second confidence set.

The fifth determination unit is configured to determine, based on the second confidence set, a group association degree of each group of neighbouring points.

In some embodiments, the fifth determination unit includes a first processing subunit, and a first determination subunit.

The first processing subunit is configured to normalize second confidences in the second confidence set, to obtain group normalization results.

The first determination subunit is configured to determine, based on the group normalization results, the group association degree of each group of neighbouring points.

In some embodiments, the second determination module 302 includes a third determination submodule, a first transformation submodule, a second transformation submodule and a first interaction submodule.

The third determination submodule is configured to determine, for each group of neighbouring points, a respective first initial feature and determine a second initial feature of the to-be-processed point.

The first transformation submodule is configured to: for each group of neighbouring points, perform linear transformation on the respective first initial feature based on a first preset numeric value, to obtain a respective first transformed feature.

The second transformation submodule is configured to perform, based on the first preset numeric value, linear transformation on the second initial feature to obtain a second transformed feature.

The first interaction submodule is configured to: for each group of neighbouring points, determine a respective relationship parameter between the respective first transformed feature and the second transformed feature to be the respective association relationship between the group of neighbouring points and the to-be-processed point.

In some embodiments, the third determination module 303 includes a third transformation submodule, and a fourth determination submodule.

The third transformation submodule is configured to: for each group of neighbouring points, perform, based on a second preset numeric value, linear transformation on the respective first initial feature to obtain a respective third transformed feature. One of the second preset numeric value and the first preset numeric value is a multiple of the other.

The fourth determination submodule is configured to: for each group of neighbouring points, determine, based on the respective association relationship and the respective third transformed feature, the respective association feature of the to-be-processed point.

In some embodiments, the fourth determination submodule includes a first aggregation unit and a second fusion unit.

The first aggregation unit is configured to: for each group of neighbouring points, aggregate the respective third transformed feature based on the respective relationship parameter, to obtain a respective aggregated feature.

The second fusion unit is configured to: for each group of neighbouring points, fuse the respective aggregated feature and the second initial feature to obtain the respective association feature of the to-be-processed point.

In some embodiments, the apparatus further includes a first transformation module and a fifth determination module.

The first transformation module is configured to perform linear transformation on the to-be-processed point, to obtain a transformed to-be-processed point.

The fifth determination module is configured to determine the plurality of groups of neighbouring points for the transformed to-be-processed point.

In some embodiments, the apparatus further includes a second transformation module, a third transformation module and a first fusion module.

The second transformation module is configured to perform linear transformation on the target feature, to obtain a core target feature.

The third transformation module is configured to perform linear transformation on a second initial feature of the to-be-processed point, to obtain a residual feature of the to-be-processed point.

The first fusion module is configured to update the target feature based on the residual feature and the core target feature, to obtain an updated target feature.

In some embodiments, the apparatus further includes a first acquisition module, a sixth determination module, a second completion module and a first cascading module.

The first acquisition module is configured to acquire original point cloud data. The sixth determination module is configured to determine probability distribution of the original point cloud data. The second completion module is configured to complete the original point cloud data based on the probability distribution, to obtain primary complete point cloud. The first cascading module is configured to cascade the primary complete point cloud and the original point cloud data to obtain the first point cloud data.

It should be noted that the above descriptions of the apparatus embodiment are similar to the above descriptions of the method embodiment, and have advantageous effects similar to those of the method embodiment. For technical details which are not disclosed in the apparatus embodiment of the disclosure, reference may be made to the descriptions of the method embodiment of the disclosure for understanding.

It should be noted that in the embodiments of the disclosure, when the method for processing point cloud data is implemented in form of software function modules and sold or used as an independent product, it may also be stored in a computer-readable storage medium. Based on such an understanding, the technical solutions of the embodiments of the disclosure substantially or parts making contributions to the related art may be embodied in form of software product, and the computer software product is stored in a storage medium, including multiple instructions configured to enable a piece of computer equipment (which may be a terminal, a server etc.) to execute all or part of the method in various embodiments of the disclosure. The storage medium includes: various media capable of storing program codes such as a USB flash disk, a mobile hard disk, a Read Only Memory (ROM), a magnetic disk or an optical disk etc. Thus, the embodiments of the disclosure are not limited to any particular combination of hardware and software.

Accordingly, an embodiment of the disclosure further provides a computer program product including computer-executable instructions which, when being executed, are capable of implementing actions of the method for processing point cloud data provided in the embodiment of the disclosure.

Accordingly, an embodiment of the disclosure further provides a computer storage medium having stored thereon computer-executable instructions which, when being executed by a processor, are capable of implementing actions of the method for processing point cloud data provided in the above embodiment.

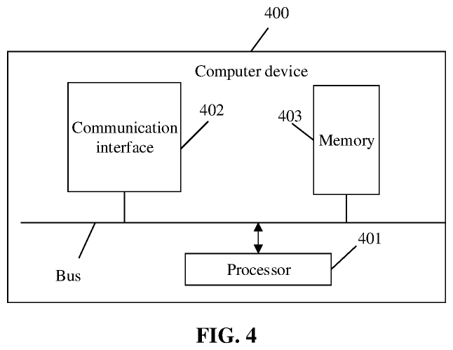

Accordingly, an embodiment of the disclosure provides a computer device. FIG. 4 illustrates a schematic diagram of a composition structure of a computer device according to an embodiment of the disclosure. As illustrated in FIG. 4, the device 400 includes a processor 401, at least one communication bus, a communication interface 402, at least one external communication interface and a memory 403. Herein the communication interface 402 is configured to implement connection communication between these components. Herein the communication interface 402 may include a display screen, and the external communication interface may include a standard wired interface and wireless interface. Herein, the processor 401 is configured to execute the image processing program in the memory to implement actions of the method for processing point cloud data provided in the above embodiment.

The above descriptions of the apparatus for processing point cloud data, the computer device and the storage medium embodiments are similar to the above descriptions of the method embodiment, and have technical descriptions and advantageous effects similar to those of the corresponding method embodiment, and may refer to the above description of the method embodiment and will not be repeated herein. For the technical details which are not disclosed in the embodiments of the disclosure for the apparatus for processing point cloud data, the computer device and the storage medium, reference may be made to the descriptions of the method embodiment of the disclosure for understanding.

It should be understood that reference to “one embodiment” or “an embodiment” throughout the specification means that a specific feature, structure or characteristic associated with the embodiment is included in at least one embodiment of the disclosure. Thus, the presence of “in one embodiment” or “in an embodiment” throughout the specification does not always refer to the same embodiment. Furthermore, these specific features, structures or characteristics may be combined in one or more embodiments in any suitable manner. It should be understood that in the embodiments of the disclosure, the magnitude of the sequence numbers of the above processes does not mean the order of execution thereof, and the order of execution of the processes should be determined by their functions and intrinsic logics, and should not form any limitation on the implementation of the embodiments of the disclosure. The sequence numbers of the above embodiments of the disclosure are for description only and do not indicate the advantages or disadvantages of the embodiments. It should be noted that in the context, the terms “comprises” “include” or any other variation thereof, are intended to cover a non-exclusive inclusion, such that a process, method, article or apparatus that includes a list of elements includes not only those elements but also other elements not clearly listed, or also includes elements inherent to such process, method, article or apparatus. Without more limitations, an element defined by the statement “include a . . . ” does not exclude that there are additional identical elements in a process, method, article or apparatus that includes the element.

In some embodiments provided in the disclosure, it should be understood that the disclosed device and method may be implemented in other manners. The device embodiment described above is only schematic, for example, division of the units is only division in logic functions, and other division manners may be taken during practical implementation. For example, multiple units or components may be combined or integrated into another system, or some features may be neglected or not executed. In addition, coupling or direct coupling or communication connection between various displayed or discussed components may be indirect coupling or communication connection implemented through some interfaces, devices or the units, and may be electrical, mechanical or in other forms.

The units described above as separate parts may or may not be physically separated, and parts displayed as units may or may not be physical units; and may be located in the same place, or may also be distributed to multiple network units; some or all of the units may be selected to achieve the purpose of the solutions in the embodiments according to a practical requirement.

In addition, functional units in various embodiments of the disclosure may be integrated into one processing unit, or each unit may be used as a single unit separately, or two or more than two units may be integrated into a unit. The integrated unit may be implemented in the form of hardware or in the form of hardware plus software functional units. It may be appreciated by those of ordinary skill in the art that all or some of the actions implementing the method embodiment may be carried out by hardware associated with program instructions, and the above program may be stored in a computer-readable storage medium. The program, when being executed, performs the actions of the method embodiment, and the storage medium includes various media capable of storing program codes such as a mobile storage device, a ROM, a magnetic disk or an optical disk etc.

When the integrated unit of the disclosure is implemented in form of software functional module and sold or used as an independent product, it may also be stored in a computer-readable storage medium. Based on such an understanding, the technical solutions of the embodiments of the disclosure substantially or parts making contributions to the related art may be embodied in form of software product, and the computer software product is stored in a storage medium, including multiple instructions configured to enable a computer device (which may be a personal computer, a server or a network device, etc.) to execute all or some of the method in various embodiments of the disclosure. The storage medium includes various media capable of storing program codes such as a mobile storage device, a ROM, a magnetic disk or an optical disk etc. Described above are merely particular embodiments of the disclosure; however, the scope of protection of the disclosure is not limited thereto. Any variations or replacements apparent to those skilled in the art within the technical scope disclosed by the disclosure shall fall within the scope of protection of the disclosure. Therefore, the scope of protection of the disclosure shall be subject to the scope of protection of the claims.

1. A method for processing point cloud data, comprising:
determining, from first point cloud data acquired, a plurality of groups of neighbouring points for a to-be-processed point, wherein each group of neighbouring points among the plurality of groups of neighbouring points has a respective different scale;
for each group of neighbouring points, determining a respective association relationship between the group of neighbouring points and the to-be-processed point;
for each group of neighbouring points, determining a respective association feature of the to-be-processed point based on the respective association relationship between the group of neighbouring points and the to-be-processed point;
determining a target feature of the to-be-processed point based on association features corresponding to the plurality of groups of neighbouring points; and
performing, based on target features of a plurality of to-be-processed points, point cloud completion on the first point cloud data to generate second point cloud data.

2. The method of claim 1, wherein determining the target feature of the to-be-processed point based on the association features corresponding to the plurality of groups of neighbouring points comprises:
performing average pooling on the association features corresponding to the plurality of groups of neighbouring points, to obtain a pooled feature;
determining, based on the pooled feature, group association degrees each between a respective group of neighbouring points and the to-be-processed point; and
determining, based on the group association degrees and the association features, the target feature of the to-be-processed point.

3. The method of claim 2, wherein performing average pooling on the association features corresponding to the plurality of groups of neighbouring points, to obtain the pooled feature comprises:
fusing the association features corresponding to the plurality of groups of neighbouring points, to obtain a fused feature; and
performing average pooling on the fused feature, to obtain the pooled feature.

4. The method of claim 2, wherein determining, based on the pooled feature, the group association degrees each between a respective group of neighbouring points and the to-be-processed point comprises:
for each group of neighbouring points, obtaining a respective point association degree set by: determining, based on the pooled feature, an association degree between each neighbouring point in the group of neighbouring points and the to-be-processed point; and
for each group of neighbouring points, determining a respective group association degree based on the respective point association degree set; and
determining, based on the group association degrees and the association features, the target feature of the to-be-processed point comprises:
for each group of neighbouring points, adjusting the respective association feature based on the respective group association degree, so as to obtain the target feature.

5. The method of claim 2, wherein determining, based on the pooled feature, the group association degrees each between a respective group of neighbouring points and the to-be-processed point comprises:
determining a first confidence that the pooled feature is a key feature of the to-be-processed point;
for each group of neighbouring points, determining, based on the first confidence, a respective second confidence that the respective association feature is the key feature, so as to obtain a second confidence set; and
determining, based on the second confidence set, a group association degree of each group of neighbouring points.

6. The method of claim 5, wherein determining, based on the second confidence set, the group association degree of each group of neighbouring points comprises:
normalizing second confidences in the second confidence set, to obtain group normalization results; and
determining, based on the group normalization results, the group association degree of each group of neighbouring points.

7. The method of claim 1, wherein for each group of neighbouring points, determining the respective association relationship between the group of neighbouring points and the to-be-processed point comprises:
determining, for each group of neighbouring points, a respective first initial feature and determining a second initial feature of the to-be-processed point;
for each group of neighbouring points, performing linear transformation on the respective first initial feature based on a first preset numeric value, to obtain a respective first transformed feature;
performing, based on the first preset numeric value, linear transformation on the second initial feature to obtain a second transformed feature; and
for each group of neighbouring points, determining a respective relationship parameter between the respective first transformed feature and the second transformed feature to be the respective association relationship between the group of neighbouring points and the to-be-processed point.

8. The method of claim 7, wherein for each group of neighbouring points, determining the respective association feature of the to-be-processed point based on the respective association relationship between the group of neighbouring points and the to-be-processed point comprises:
for each group of neighbouring points, performing, based on a second preset numeric value, linear transformation on the respective first initial feature to obtain a respective third transformed feature, wherein one of the second preset numeric value and the first preset numeric value is a multiple of the other; and
for each group of neighbouring points, determining, based on the respective association relationship and the respective third transformed feature, the respective association feature of the to-be-processed point.

9. The method of claim 8, wherein for each group of neighbouring points, determining, based on the respective association relationship and the respective third transformed feature, the respective association feature of the to-be-processed point comprises:
for each group of neighbouring points, aggregating the respective third transformed feature based on the respective relationship parameter, to obtain a respective aggregated feature; and
for each group of neighbouring points, fusing the respective aggregated feature and the second initial feature to obtain the respective association feature of the to-be-processed point.

10. The method according to claim 1, before determining, from the first point cloud data acquired, the plurality of groups of neighbouring points for the to-be-processed point, the method further comprises:
performing linear transformation on the to-be-processed point, to obtain a transformed to-be-processed point; and
determining the plurality of groups of neighbouring points for the transformed to-be-processed point.

11. The method according to claim 2, wherein after determining the target feature of the to-be-processed point based on the association features corresponding to the plurality of groups of neighbouring points, the method further comprises:
performing linear transformation on the target feature, to obtain a core target feature;
performing linear transformation on a second initial feature of the to-be-processed point, to obtain a residual feature of the to-be-processed point; and
updating the target feature based on the residual feature and the core target feature, to obtain an updated target feature.

12. The method according to claim 1, further comprising:
acquiring original point cloud data;
determining probability distribution of the original point cloud data;
completing the original point cloud data based on the probability distribution, to obtain primary complete point cloud; and
cascading the primary complete point cloud and the original point cloud data to obtain the first point cloud data.

13. An apparatus for processing point cloud data, comprising:
a processor; and
a memory configured to store instructions which, when being executed by the processor, cause the processor to carry out the following:
determining, from first point cloud data acquired, a plurality of groups of neighbouring points of any to-be-processed point, wherein each group of neighbouring points among the plurality of groups of neighbouring points has a respective different scale;
for each group of neighbouring points, determining a respective association relationship between the group of neighbouring points and the to-be-processed point;
for each group of neighbouring points, determining, based on the respective association relationship between the group of neighbouring points and the to-be-processed point, a respective association feature of the to-be-processed point;
determining a target feature of the to-be-processed point based on association features corresponding to the plurality of groups of neighbouring points; and
performing, based on target features of a plurality of to-be-processed points, point cloud completion on the first point cloud data to generate second point cloud data.

14. The apparatus according to claim 13, wherein in determining the target feature of the to-be-processed point based on the association features corresponding to the plurality of groups of neighbouring points, the processor is further caused to carry out the following:
performing average pooling on the association features corresponding to the plurality of groups of neighbouring points, to obtain a pooled feature;
determining, based on the pooled feature, group association degrees each between a respective group of neighbouring points and the to-be-processed point; and
determining, based on the group association degrees and the association features, the target feature of the to-be-processed point.

15. The apparatus of claim 14, wherein in performing average pooling on the association features corresponding to the plurality of groups of neighbouring points, to obtain the pooled feature, the processor is further caused to carry out the following:
fusing the association features corresponding to the plurality of groups of neighbouring points, to obtain a fused feature; and
performing average pooling on the fused feature, to obtain the pooled feature.

16. The apparatus of claim 14, wherein in determining, based on the pooled feature, the group association degrees each between a respective group of neighbouring points and the to-be-processed point, the processor is caused to perform the following:
for each group of neighbouring points, obtaining a respective point association degree set by: determining, based on the pooled feature, an association degree between each neighbouring point in the group of neighbouring points and the to-be-processed point; and
for each group of neighbouring points, determining a respective group association degree based on the respective point association degree set; and
in determining, based on the group association degrees and the association features, the target feature of the to-be-processed point, the processor is caused to perform the following:
for each group of neighbouring points, adjusting the respective association feature based on the respective group association degree, so as to obtain the target feature.

17. The apparatus of claim 14, wherein in determining, based on the pooled feature, the group association degrees each between a respective group of neighbouring points and the to-be-processed point, the processor is caused to perform the following:
determining a first confidence that the pooled feature is a key feature of the to-be-processed point;
for each group of neighbouring points, determining, based on the first confidence, a respective second confidence that the respective association feature is the key feature, so as to obtain a second confidence set; and
determining, based on the second confidence set, a group association degree of each group of neighbouring points.

18. The apparatus of claim 17, wherein in determining, based on the second confidence set, the group association degree of each group of neighbouring points, the processor is caused to carry out the following:
normalizing second confidences in the second confidence set, to obtain group normalization results; and
determining, based on the group normalization results, the group association degree of each group of neighbouring points.

19. The apparatus of claim 13, wherein in determining, for each group of neighbouring points, the respective association relationship between the group of neighbouring points and the to-be-processed point the processor is further caused to carry out the following:
determining, for each group of neighbouring points, a respective first initial feature and determining a second initial feature of the to-be-processed point;
for each group of neighbouring points, performing linear transformation on the respective first initial feature based on a first preset numeric value, to obtain a respective first transformed feature;
performing, based on the first preset numeric value, linear transformation on the second initial feature to obtain a second transformed feature; and
for each group of neighbouring points, determining a respective relationship parameter between the respective first transformed feature and the second transformed feature to be the respective association relationship between the group of neighbouring points and the to-be-processed point.

20. A non-transitory computer storage medium having stored thereon computer-executable instructions which, when being executed, are capable of implementing following actions:
determining, from first point cloud data acquired, a plurality of groups of neighbouring points for a to-be-processed point, wherein each group of neighbouring points among the plurality of groups of neighbouring points has a respective different scale;
for each group of neighbouring points, determining a respective association relationship between the group of neighbouring points and the to-be-processed point;
for each group of neighbouring points, determining a respective association feature of the to-be-processed point based on the respective association relationship between the group of neighbouring points and the to-be-processed point;
determining a target feature of the to-be-processed point based on association features corresponding to the plurality of groups of neighbouring points; and
performing, based on target features of a plurality of to-be-processed points, point cloud completion on the first point cloud data to generate second point cloud data.
